(19) United States
(12) Patent Application Publication
(10) Pub. No.: US 2026/0037624 A1
(43) Pub. Date: Feb. 5, 2026

(54) Method and system for preventing application programming interface attacks via channel for transmission of data

(71) Applicants: Kaushal Balkrishna Shah, Mumbai (IN); Suhas Ramkrishna Dalvi, Pune (IN); Shreekumar Radhakrishnan Nair, Bengaluru (IN); Rajesh Arjun Gawde, Thane (IN); Mrunalini Uttam Khot, Thane (IN)

(72) Inventor: Kaushal Balkrishna Shah, Mumbai (IN)

(21) Appl. No.: 19/099,787

(22) PCT Filed: Aug. 3, 2023
(86) PCT No.: PCT/IB2023/057863

§ 371 Date: Jan. 30, 2025

(30) Foreign Application Priority Data
Aug. 4, 2022 (IN) 202221032034

(51) Int. Cl. G06F 21/55; G06F 21/44; G06F 21/62

(52) U.S. Cl. CPC G06F 21/554; G06F 21/44; G06F 21/62; G06F 2221/2141

(57) ABSTRACT

Disclosed herein is a system and method for preventing API attacks using a channel for transmission of data, particularly via an API Virtual Server having an admin panel, a Request Process Flow, a Response Process Flow, and an API event log Database that provision for virtual addressing of the API and creation of unique sessions for API calls.

Cross references to related applications: This application is filed further to international application No. PCT/IB2023/057863 which claims priority from Indian Patent Application number 202221032034 dated Apr. 8, 2022 being filed before the Indian Patent Office, and the entire disclosure of that patent application is hereby incorporated by reference.

### FIELD OF THE INVENTION

The present invention is in the field of cyber security. In particular, the present invention directed to system and method for preventing API attacks using a channel for transmission of data.

### Definitions and Interpretations

Before undertaking the detailed description of the invention below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect, with, contain, be contained within, connect to or with, couple to or with, be communicable with, cooperate with, interleave, juxtapose, be proximate to, be bound to or with, have, have a property of, or the like; and the underlying terms shall mean and refer to, as under—
“API” refers to Application Programming Interface.
“Malware” refers to malicious software which comes in the form of code, executables, scripts, active content, and other software forms as well as potential streams of input/output, such as a stream of network packets that causes an attack.
“IoT” refers to Internet-of-Things
“API traffic” shall refer and may include any data format, such as XML, Extensible Markup Language, (for example as in the Simple Object Access Protocol (SOAP) protocol), binary data, unstructured data etc. In another example, API's may be generally anything you send a request to a server and get data back, even a Hypertext Transfer Protocol (HTTP) request that returns Hypertext Markup Language (HTML) may be considered an API.

Although embodiments of the invention are not limited in this regard, discussions utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Unless explicitly stated, the method embodiments described herein are not constrained to a particular order or sequence. Additionally, some of the described method embodiments or elements thereof may occur or be performed simultaneously, at the same point in time, or concurrently.

### Background of the Invention & Description of Related Art

An API is understood as a particular set of rules and specifications that a software program can follow in order to access and make use of the services and resources provided by another particular software program that implements that API. In other words, APIs allow software applications to communicate with each other so that users and programs can use the applications to accomplish any number of tasks such as information gathering, social communication, e-commerce transactions, accessing entertainment, educational content, etc.

APIs can include a set of subroutine definitions, communication protocols, and other tools for building and managing software applications and interactions between components of the software applications. Thus, an API serves as an interface between different software programs and facilitates their interaction, similar to the way that the user interface facilitates interaction between humans and computers. APIs are often used in a client-server architecture, to enable direct interfacing between a client device (or “client”) and a server device (or “server”), e.g., over a network such as the Internet. In such architecture, API calls are typically sent back and forth between a client and a server in the form of requests (from the client device) and responses (from the server devices).

As a matter of course, different companies, which provide various different services, functionalities, and/or information, design and deploy their own unique APIs having their own unique data structures, etc. Furthermore, there are many different types of API architectures (e.g., RESTful, SOAP, XML-RPC, etc.), which may be implemented in a variety of different situations, such as Public APIs (available to developers), Private APIs (unavailable to developers), Internal APIs, third party APIs, and may relate to any number of specific applications such as, for example, mobile applications, web application, internet-of-things (IOT) applications and technologies, etc. APIs may also be configured for a variety of common data protocols (e.g., (JSON, XML, YAML, etc.), over a variety of communication protocols (Ethernet, IP, TCP, UDP, HTTP, HTTPS, HTTP/2, Web-Socket, etc.). With so many variables, each unique API will have its own unique vulnerabilities to attack by hackers, etc.

As will be now evident to the reader hereof, it is very important to implement security measures in transactions mediated through API traffic. Driven by the rapid increase in mobile and IoT devices, APIs and micro-services are increasingly used to make business logic and data more accessible to users. APIs, however, can make it easier for malicious users and programs to access business applications, control systems, and databases. Thus, a need exists for improved apparatuses and methods for effective monitoring and analysis of API traffic to identify and/or thwart potential malicious actions.

Most APIs are vulnerable to advanced persistent threat (APT) attacks, zero day attacks, and other similar attacks which look to exploit the vulnerabilities of a company's APL. Moreover, developers put limited attention to security, and continued development of an API requires careful review of implemented legacy security systems and either updates for security assurance or using the developer's own code for security assurance and validity. The current state of the art creates opportunities for exploiting vulnerabilities and enhances security challenges.

Generally, when an attacker wants to attack an API and details regarding that API are not publicly available, there are a number of steps/processes often taken to learn about the API, such as:
a) Reconnaissance-“Sniffing” or otherwise listening to the traffic back and forth between the client and the server in order to document the structure, communication protocols, etc., of the API and reverse-engineering the information to get a complete picture of the API;
b) Generating illegal requests-Once all the API details are known, the attacker can begin sending illegal requests directly to the backend of the server (rather than following the set API protocols, which typically only allow forward-facing communication, e.g., via a mobile application). These calls can include malicious code which can change parameters, add invalid inputs, etc., and may eventually expose a vulnerability of the API; and
c) Attack-Upon finding a vulnerability, implementing an attack on the server via the APL.

Presently available cyber-security systems do not resolve these fundamental flaws, as they account only for “known attacks”, e.g., attacks that have identifiable signatures that can be monitored for and blocked, for example monitoring calls for a specific term, etc. However, unknown vulnerabilities, which are specific to each API, cannot be accounted for using these methods. Instead, a customized solution that channelizes transmission of the data via virtual addressing system for API business logic.

Another issue with cyber security is that security vendors generally issue static and dynamic signatures and detection patterns to recognize malware. On the other hand, all hackers need to do is perform minor changes in the already identified and documented malware to thereby systematically evade these detection methods. Thus, the art needs some means which are insulated from such vulnerability from “re-used” malware having minor changes.

While there were many common art references researched by the inventor(s) in ensuring that the present invention is novel, the following patent prior art was identified as related to the present invention, and thus worthwhile to discuss in more detail in context of the present invention.

For example, U.S. Pat. No. 9,853,996B2 (2016; Assigned to Salt Security Inc) discloses a system and method for identifying and preventing malicious application programming interface attacks. The approach propounded here involves two distinct stages-a learning stage, and a protection stage. During the learning stage, all requests sent to a server-side API over the network and all responses sent from the server-side API over the network are monitored, identified by one or more first characteristic data points to output one or more characteristic data models. During the protection stage, the one or more characteristic data models so established are used for validating or invalidating a future request and response, and furthermore tagging suspicion scores to sources of said requests, to hence flag down such sources in future irrespective of validation.

Another reference, US20070083933A1 (2005; Assigned to Microsoft Technology Licensing LLC) teach methods and systems for analyzing a computer program use static and interprocedural analysis techniques and engines. Here, security vulnerabilities in computer programs are identified, which represent a potential source for entry of untrusted data into the computer program. A course of the untrusted data is modeled through the identified function to produce a validation result, to thus map attribute/s of the untrusted data which is used to output an validation result via an via an API, software development tool, or user interface.

AU2014213584A (2014; Filed by Shlomi Boutnaru) suggests a predictive security product. This invention provides products, methods and systems for predicting future malware based on evolutionary principles and protecting against such malicious elements and other similar elements. Mainly involved are a malware evolution engine adapted to generate malware variants of malware specimens and an evaluator configured to evaluate said malware variants based on at least one of: a maliciousness level and an evasiveness level.

EP3471007B1 (2018; Assigned to Ping Identity Corp) suggests a method to map API calls being received from a client device, said calls having a specific sequence. This mapping is used to establish a predicted sequence of API calls associated with any instance of an API call. Based on predicted sequence, a combined consistency score is established and, depending on predetermined thresholds of variance in said consistency, determination between instances of API calls being genuine or malicious is made.

U.S. Pat. No. 11,425,129B1 (2022; Filed by Yaron Oliker) suggests an approach of securing communication between a server and a client device. Here, a server's object references are identified by analyzing the payload of an API. The server's object reference and client reference are encrypted before dispatch. Distinction between genuine or otherwise, is made on basis of matching or not between the decrypted client reference and the authenticated client reference.

As visible in the immediate technical domain of the present invention, there have been many attempts to provide malware detection methodologies/software and security packages that protect individual users and corporate networks from various types of malware and unwanted intrusions. However, virtually no vendors, products or packages provide technology for protecting application programming interface attacks while being shielded from the wants voiced above. Therefore, a great objective and empirical difficulty exists in allowing a user to chose the apt security method/product for safeguarding against application programming interface attacks.

State-of-art therefore, does not list a single effective solution embracing all considerations mentioned hereinabove, thus preserving an acute necessity-to-invent for the present inventor/s who, as result of focused research, has come up with novel solutions for resolving all needs once and for all. Work of the presently named inventor/s, specifically directed against the technical problems recited hereinabove and currently part of the public domain including earlier filed patent applications, is neither expressly nor impliedly admitted as prior art against the present disclosures.

A better understanding of the objects, advantages, features, properties and relationships of the present invention will be obtained from the following detailed description which sets forth an illustrative yet-preferred embodiment.

### Objectives of the Present Invention

The present invention is identified in addressing at least all major deficiencies of art discussed in the foregoing section by effectively addressing the objectives stated under, of which:

It is a primary objective to provide a method and its implementing system, for effectively preventing application programming interface attacks, which is immune to the approach used for the attack.

It is another objective further to the aforesaid objective(s) to provision virtual addressing of the API, thereby ensuring security against API attacks.

It is another objective further to the aforesaid objective(s) to provision unique sessions for API calls, thereby ensuring security against API attacks.

It is another objective further to the aforesaid objective(s) that the method and its implementing system so provisioned allow implementation without any, or minimal if at all, modifications to existing system architectures.

It is another objective further to the aforesaid objective(s) that the method and its implementing system so provisioned allow implementation without entailing undue technical complexities and/or costs.

The manner in which the above objectives are achieved, together with other objects and advantages which will become subsequently apparent, reside in the detailed description set forth below in reference to the accompanying drawings and furthermore specifically outlined in the independent claims. Other advantageous embodiments of the invention are specified in the dependent claims.

### BRIEF DESCRIPTION OF DRAWINGS

The present invention is explained herein under with reference to the following drawings, in which-FIG. 1 is a schematic representation of the system architecture foundation of the present invention.

FIG. 2 is a schematic representation of the Request Process Flow involved in implementation of the present invention.

FIG. 3 is a schematic representation of the Response Process Flow involved in implementation of the present invention.

FIG. 4 is a schematic representation of the system environment of the present invention, showcasing primarily the role of the API Virtual Server in accordance with the present invention.

The above drawings are illustrative of particular examples of the present invention, more intended for their simplicity and clarity of illustration, but are not intended to limit the scope thereof. The drawings are not to scale (unless so stated) and are intended for use solely in conjunction with their explanations in the following detailed description. In above drawings, wherever possible, the same references and symbols have been used throughout to refer to the same or similar parts, as under—
01—Request Process Flow
02—Response Process Flow
03—API Virtual Server
04—Admin Panel
05—API event log Database
06—Wrapped Business Logic API Access
S1 to S8—Stages involved in 01
T1 to T7—Stages involved in 02

It shall be appreciated however, that in other instances, well-known methods, procedures, and components, modules, units and/or functions have not been described in detail so as not to obscure the invention. Some features or elements described with respect to one embodiment may be combined with features or elements described with respect to other embodiments. For the sake of clarity, discussion of same or similar features or elements may not be repeated.

Attention of the reader is now requested to the detailed description to follow which narrates a preferred embodiment of the present invention and such other ways in which principles of the invention may be employed without parting from the essence of the invention claimed herein.

### DETAILED DESCRIPTION

Principally, the present invention is directed at absorbing all advantages of prior art while overcoming, and not imbibing, any of its shortfalls, to thereby establish a system and method for preventing API attacks using a channel for transmission of data.

As will be understood while undertaking the disclosures to follow, that the present invention is capable of various other embodiments and that its several components and related details are capable of various alterations, all without departing from the basic concept of the present invention. Accordingly, various embodiments have been presented. Each of these embodiments may of course include features from other embodiments presented, and embodiments not specifically described may include various features described herein.

System Architecture: System architecture foundation of the present invention is defined to secure—
a) Firstly, the business logic API calls for data access from the request to response;
b) Secondly, the business logic API wrapped under the virtual servers;
c) Thirdly, the virtual servers mapped as per the configuration on the business logic API; and
d) Fourth and last, the data moved to call by reference.

The system and method for preventing API attacks using a channel for transmission of data, as proposed via the present invention, is implemented via virtual addressing system of API which enables a unique session for establishing API calls of business logic. This API calls invokes a method wherein client request gets verified with multifactor authentication before allocating session to access business logic API. All the protocol communication defined under this unique method where API call consists of business logic are wrapped under virtual addressing system of API.

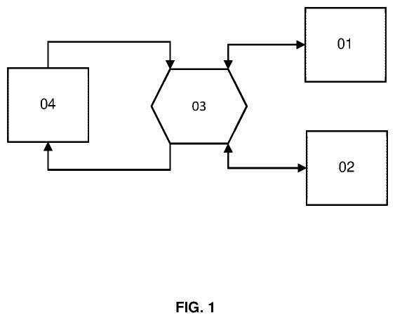

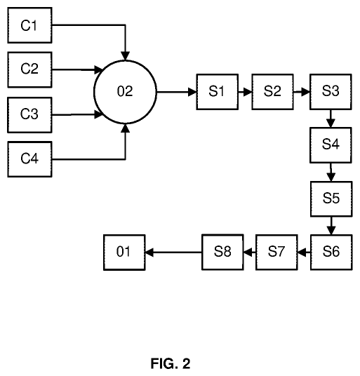

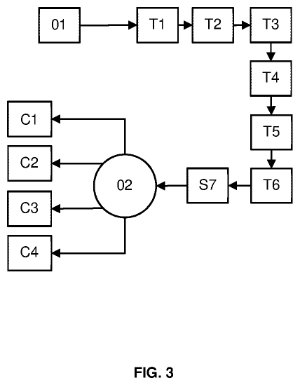

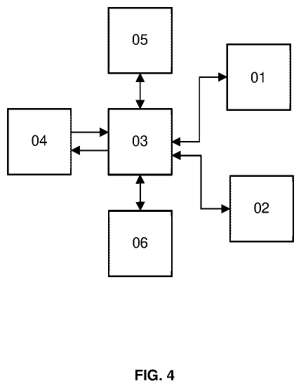

As particularly shown in the accompanying FIG. 1, the system architecture has been distributed in 4 areas-Request Process Flow (01), Response Process Flow (02), API Virtual Server (03) and Admin Panel (04). Each of which are explained in further detail in the later part of this document, as under—
a) Request Process Flow: As seen in the accompanying FIG. 2, the Client initiates the request for data via API from the web. The Request Process Flow consists of 8 stages, namely—
   (S1)—Request from client on the API access.
   (S2)—Secured authorization access having initial validation, said validation being performed on basis of matching between end-user/client authenticated values that is, user ID, password, Session ID, Mac ID-lack of matching of any of these terminates the process.
   (S3)—Load Balancer (if any) to route request with client on the API access.
   (S4)—Middleware components for the API access as per the client authorized access; said middleware components being selected from Apache, Oracle weblogic server, IBM websphere, JBoss, Kubernates, OpenStack and the like
   (S5)—Client identity authentication process.
   (S6)—Virtual session generation for the authenticated client.
   (S7)—Business Logic API wrapped in the virtual session access to authenticated client.
   (S8)—Logging of events at the central server running parallel to the business logic related data access.
b) Response Process Flow: As seen in the accompanying FIG. 3, the Client receives responses for data via API from the web. The Response Process Flow consist of 7 stages, namely—
   (T1)—Data conversion using call by reference method.
   (T2)—Generating response from business logic API wrapped in the virtual session server access.
   (T3)—Logging of events at the central server for virtual session server access.
   (T4)—Call by reference data with client ID and session id to middleware server.
   (T5)—Call by reference data with client ID and session id to Load balancer.
   (T6)—Generating response to the Firewall through call by reference data with client ID.
   (T7)—Generating response to public/static URL through call by reference data with client ID.
c) API Virtual Server: As seen in the accompanying FIG. 3, the API virtual server (03) consists of Admin Panel (Console-04), API event log Database (05), Request process flow (01) as well as Response process flow (02) for allowing wrapped business logic API (06) and Business logic API access details of all types of API (e.g., RESTful, SOAP, XML-RPC, etc.), which may be implemented, as mentioned in the background section of this document, in a variety of different situations, such as Public APIs (available to developers), Private APIs (unavailable to developers), Internal APIs, third party APIs, and may relate to any number of specific applications such as, for example, mobile applications, web application, internet-of-things (IOT) applications and technologies, etc. APIs may also be configured for a variety of common data protocols (e.g., (JSON, XML, YAML, etc.), over a variety of communication protocols (Ethernet, IP, TCP, UDP, HTTP, HTTPS, HTTP/2, Web-Socket, etc.).
d) Admin Panel: Admin Panel (04) consists of details of Business Logic mapping, API data type (Video, Audio, Standard Data), API Data distribution (Critical, Major and Minor), Allowed Application Details (API access with View only, View and Write, View and Query, etc.), API execution time in Seconds (Default value is “0”, 30,60,90, . . . 999999), If API execution time more than 30 seconds then session verification process to eliminate API data Vulnerability, Authentication while first time access of API [Yes/No], Client Whitelisting process, Client Access details [Laptop/Mobile/Desktop] Device Mac Address is Must.

It shall be appreciated that predetermined threshold of time (30 seconds mentioned above) is not absolute but can be more or less depending on the infrastructure allocated, including the server, processor, software etcetera within the application environment of the use-case intended.

### Reduction to Practice:

The present invention has been reduced to practice by the applicants named herein, and in independent trials, observed to be successfully deployable in a variety of application environments/use-cases, to name a few—
a) Core banking software, wherein the business logic is for data integration with mobile based applications; and
b) Gaming industry, wherein the business logic is provision of customer balance/live updating of credit values in response to playing of an online game.

From the foregoing narration, an able methodology and its implementing system for preventing API attacks using a channel for transmission of data is thus provided with marked novelty, inventive contribution, and industrial applicability than any background and/or prior art.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Accordingly, the foregoing description will be regarded as illustrative in nature and not as restrictive in any form whatsoever. Modifications and variations of the system and apparatus described herein will be obvious to those skilled in the art. Such modifications and variations are intended to come within ambit of the present invention, which is limited only by the appended claims.

We claim:

1. A method for preventing application programming interface attacks, comprising the definition of a secure system architecture characteristically having an API Virtual Server having an admin panel, a Request Process Flow, a Response Process Flow, and an API event log Database that provision for virtual addressing of the API and creation of unique sessions for API calls, thereby securing—
a) Business logic API calls for data access from the request to response;
b) Business logic API wrapped under the virtual servers;
c) Virtual servers mapped as per the configuration on the business logic API; and
d) Data moved to call by reference.

2. The method for preventing application programming interface attacks as claimed in claim 1, wherein the Request Process Flow for data via API from the web comprises—
a) Generating, from a client, a request for API access;
b) on basis of end-user/client authenticated values that is, user ID, password, Session ID, Mac ID, subjecting the request generated to an initial validation for secured authorization of API access, and terminating the process if validation of any of these values is negative;
c) Routing the validated request, via a load balancer if any, for optimal API access;
d) Initializing middleware components, if any, as per the client-authorized access, said middleware components being selected from Apache, Oracle weblogic server, IBM websphere, JBoss, Kubernates, OpenStack and the like;
e) At the API server, authenticating the client identity, and
i. If authentication is positive, generating a virtual communication session for the authenticated client; and
ii. If authentication is negative, terminating the process.
f) Business Logic API wrapped in virtual communication session access to the authenticated client; and
g) Logging, at a central server running parallel to the data access so provisioned, events in steps a) to f) above.

3. The method for preventing application programming interface attacks as claimed in claims 1 and 2, wherein the Response Process Flow comprises—
a) Conversion of data via using call by reference method;
b) Generating a response from the business logic API wrapped in the virtual session server access;
c) Logging, at a central server, events in steps a) to b) for virtual session server access;
d) Routing the call by reference data tagged with client ID and session ID to the middleware server;
e) Routing the call by reference data tagged with client ID and session ID to the load balancer;
f) Generating response to the firewall through call by reference data with client ID; and
g) Generating response to public/static URL through call by reference data with client ID.

4. The method for preventing application programming interface attacks as claimed in claim 1, wherein the admin panel consists of details of Business Logic mapping, API data type, Allowed Application Details, API execution time in Seconds.

5. The method for preventing application programming interface attacks as claimed in claim 4, wherein the API data type is chosen among Video, Audio, and Standard Data.

6. The method for preventing application programming interface attacks as claimed in claim 4, wherein the API Data distribution is selected between Critical, Major and Minor.

7. The method for preventing application programming interface attacks as claimed in claim 4, wherein the Allowed Application Details are selected among API access with View only, View and Write, View and Query.

8. The method for preventing application programming interface attacks as claimed in claim 1, further including at least one among—
a) a session verification process is triggered to eliminate API data Vulnerability if the API execution time exceeds a predetermined threshold of time, according to the infrastructure allocated, including the server, processor, software etcetera;
b) Authentication process while first time access of API;
c) Client Whitelisting process, for avoiding priorly known malicious or suspicious clients;
d) Client Access details, identified among access through laptop, mobile, or desktop; and
e) Location ID of client, being Device Mac Address in particular.

9. A system for preventing application programming interface attacks via channel for transmission of data, comprising the system architecture of claim 1.
